(19) United States
(12) Patent Application Publication
(10) Pub. No.: US 2008/0175420 A1
(43) Pub. Date: Jul. 24, 2008

(54) MEDIA PLAYER CAPABLE OF AUTOMATICALLY ADJUSTING EQUALIZER PARAMETERS THEREOF

(75) Inventors: Shin-Hong Chung, Shenzhen City (CN); Kuan-Hong Hsieh, Shenzhen City (CN); Xiao-Guang Li, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/972,631

(22) Filed: Jan. 11, 2008

(30) Foreign Application Priority Data
Jan. 19, 2007 (CN) 200710200076.9

(51) Int. Cl. H04R 5/02

(52) U.S. Cl. 381/309

(57) ABSTRACT

A media player capable of automatically adjusting equalizer parameter thereof is provided. The media player includes a speaker, a processor, a memory, an audio amplifier, a decoder, an analog to digital (D/A) converter, an earphone jack for connecting with an earphone, a switch and a detecting circuit. The memory stores audio files and a voltage value-equalizer parameter look-up table. The detecting circuit detects a voltage of the speaker or the second dynamic contact of the switch and obtains a voltage value. The processor compares the voltage value with predetermined voltage values and obtains a comparison result, and reads corresponding equalizer parameters from the table according to the comparison result. The media player plays an audio files according to the equalizer parameters, thus to obtain audio effect optimization.

### BACKGROUND OF THE INVENTION

1. Field of the Invention

The present invention relates to media players, and particularly to a media player which can automatically adjust an equalizer's parameters thereof.

2. General Background

Many electronic devices, such as a media player may include an internal speaker and/or an accessory interface that allows connection for an external audio accessory such as an earphone, an external speaker, or the like, for outputting audible sound. In many cases, the electronic device is optimized to work with a selected internal speaker or the external audio accessory. However, because of variations for selecting the internal speaker and/or the external earphone to output the audible sound, the equalizer parameters of the media player need to be readjusted in order that a user can obtain an ideal audio effect. This is inconvenient to the user who needs to manually adjust the equalizer parameter.

Therefore, it is necessary to provide a media player which can automatically adjust equalizer parameters thereof.

### SUMMARY OF INVENTION

A media player capable of automatically adjust equalizer parameters thereof is provided. The media player includes a speaker, a processor, a memory for storing audio files and a voltage value-equalizer parameter look-up table, an audio amplifier, a digital to analog (D/A) converter, a decoder, an earphone jack connected with an earphone, and a switch for selecting the speaker or the earphone to output an audible sound. The media player further includes a detecting circuit for detecting a voltage of the speaker or the second dynamic contact of the switch and obtains a detected voltage value. The processor compares the detected voltage value with the predetermined voltage value and obtains a comparison result, reads corresponding equalizer parameter from the memory according to the comparison result. The decoder decodes an audio file to digital audio signals, the A/D converter converts the digital audio signals to analog audio signals. The audio amplifier amplifies the analog audio signals according to the equalizer parameter read by the processor. The analog audio signals are converted to audible sound waves through the speaker or the earphone jack selected by the switch, thereby obtaining an ideal audio effect.

Other features and advantages will be apparent to one with skill in the art upon examination of the following drawings and detailed description.

### BRIEF DESCRIPTION OF DRAWINGS

FIG. 1 is a block diagram of a media player which can automatically adjust equalizer parameters thereof according to a first embodiment of the invention.

FIG. 2 shows details of an earphone jack of the media player of FIG. 1.

FIG. 3 shows details of the earphone jack of FIG. 1, the earphone jack being connected with an earphone.

FIG. 4 shows a voltage value-equalizer parameter look-up table stored in the media player of FIG. 1.

FIG. 5 is a block diagram of a media player which can automatically adjust equalizer parameters thereof according to a second embodiment of the invention.

FIG. 6 shows details of an earphone jack of the media player of FIG. 5.

FIG. 7 shows details of the earphone jack of FIG. 5, the earphone jack being connected with an earphone.

FIG. 8 shows a voltage value-equalizer parameter look-up table stored in the media player of FIG. 5.

### DETAILED DESCRIPTION OF THE EMBODIMENTS

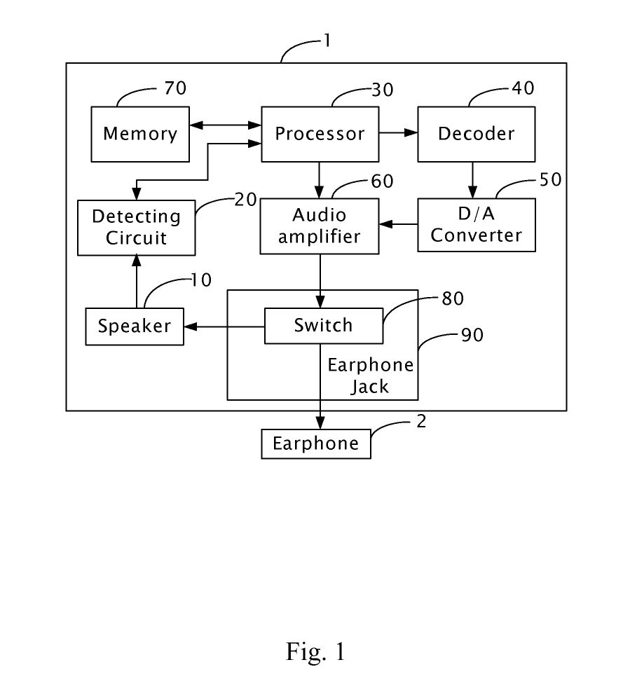

FIG. 1 is a block diagram of a media player which can automatically adjust an equalizer's parameters thereof according to a first embodiment of the invention. The media player 1 includes a speaker 10, a processor 30, a decoder 40, a digital to analog (D/A) converter 50, an audio amplifier 60, a memory 70, a switch 80 and an earphone jack 90 which is used to connect with an earphone 2. The media player 1 further includes a detecting circuit 20 configured for periodically detecting a voltage of the speaker 10 and obtaining a detected voltage value. The processor 30 compares the detected voltage value with predetermined voltage value stored in the memory 70 and obtains a comparison result. The processor 30 reads corresponding equalizer parameters from the memory 70 according to the comparison result. In particular, the memory 70 stores audio files and two types of equalizer parameters. One type of the equalizer parameters is suitable for a speaker output mode (hereinafter “EQₛₚₑₐₖₑᵣ”), and the other type is suitable for an earphone output mode (hereinafter “EQₑₐᵣₚₕₒₙₑ”). The decoder 40 is configured for decoding the audio files to digital audio signals. The D/A converter 50 is configured for converting digital audio signals outputted by the decoder 40 into analog audio signals. The audio amplifier 60 is configured for amplifying the analog audio signals according to the equalizer parameters read from the memory 70 by the processor 30. The switch 80 is configured for selecting the speaker 10 or the earphone 2 to output audible sound according to the analog audio signals outputted by the amplifier 60.

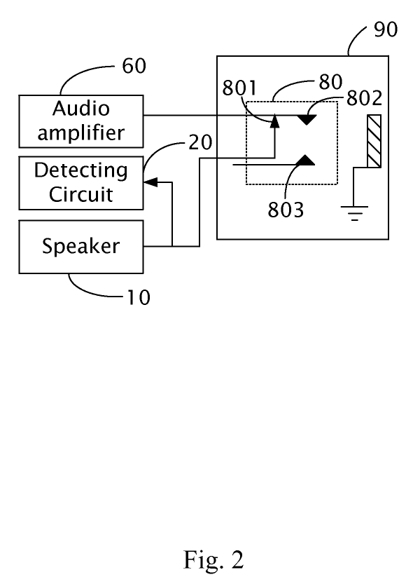

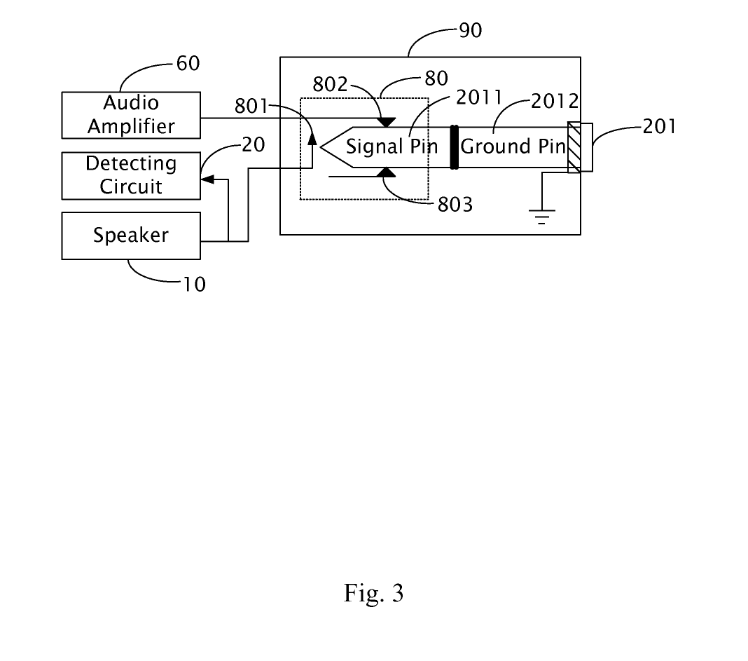

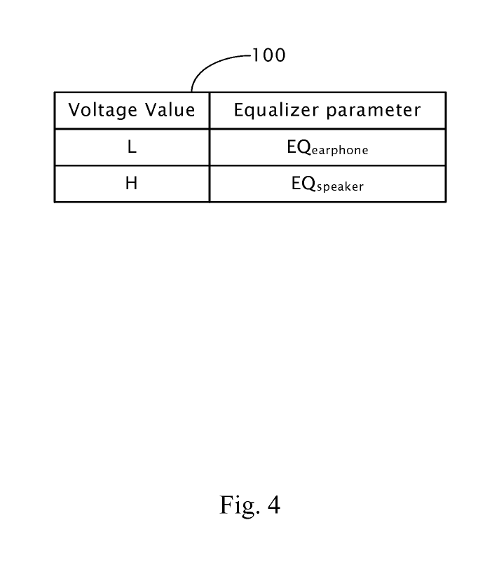

Refer to FIGS. 2, 3 and 4. FIGS. 2 and 3 both show details of the earphone jack 90. In FIG. 3, the earphone 2 is inserted in the earphone jack 90; however, FIG. 2 is not shown with the earphone jack 90. FIG. 4 shows a voltage value-equalizer parameter look-up table 100. The table 100 defines a corresponding relationship between a plurality of voltage values and a plurality of equalizer parameters. In the first embodiment, the switch 80 includes a static contact 801, a first dynamic contact 802 and a second dynamic contact 803. The static contact 801 electrically connects with the speaker 10. The first dynamic contact 802 electrically connects with the audio amplifier 60; and the second dynamic contact 803 is suspended. The switch 80 is configured inside of the earphone jack 90. When the earphone jack 90 is empty, the static contact 801 connects with the first dynamic contact 802 and the media player 1 is accordingly in the speaker output mode. The analog audio signals from the audio amplifier 60 are supplied to the speaker 10 via the static contact 801 and the first dynamic contact 802. The speaker 10 outputs audible sound according to the analog audio signals.

The detecting circuit 20 detects a voltage of the speaker 10 and outputs a high level voltage value if the media player 1 is in the speaker outputting mode. The processor 30 compares the high level voltage value with the predetermined voltage value stored in the memory 70, and reads equalizer parameters suitable for speaker output mode (EQₛₚₑₐₖₑᵣ) in accordance with the table 100. The media player 1 processes audio file according to the EQₛₚₑₐₖₑᵣ, and outputs audible sounds via the speaker 10.

When the earphone plug 201 of the earphone 2 is inserted into the earphone jack 90, the first dynamic contact 802 electrically connects with an audio signal pin 2011 of the earphone plug 201, and is disconnected from the static contact 801. A ground pin 2012 of the earphone 201 is grounded. The analog audio signals outputted by the audio amplifier 60 are transmitted to the earphone 2. The detecting circuit 20 obtains a low level voltage value from the speaker 10 and transmits the low level voltage value to the processor 30. The processor 30 compares the low level voltage value with the predetermined voltage value stored in the memory 70, and reads the EQₑₐᵣₚₕₒₙₑ in accordance with the table 100. The media player 1 processes the audio signals according to the EQₑₐᵣₚₕₒₙₑ, and outputs audible sounds through the earphone 2.

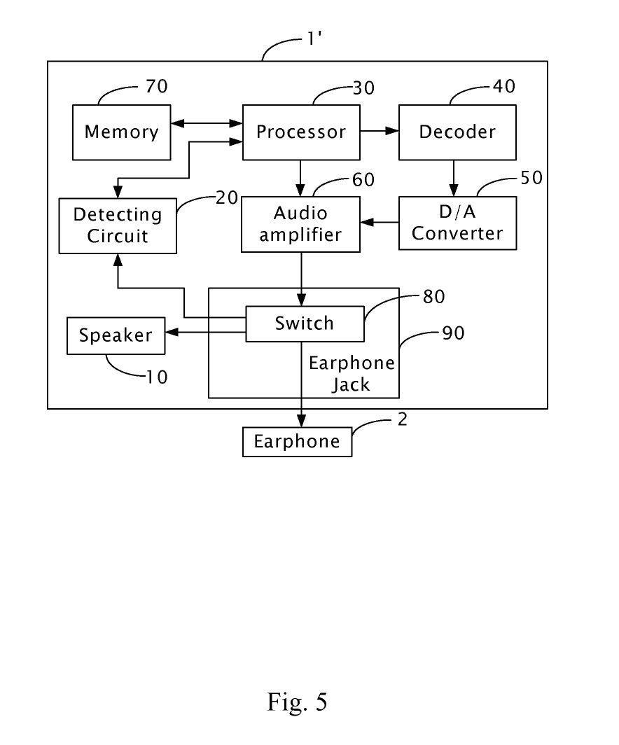

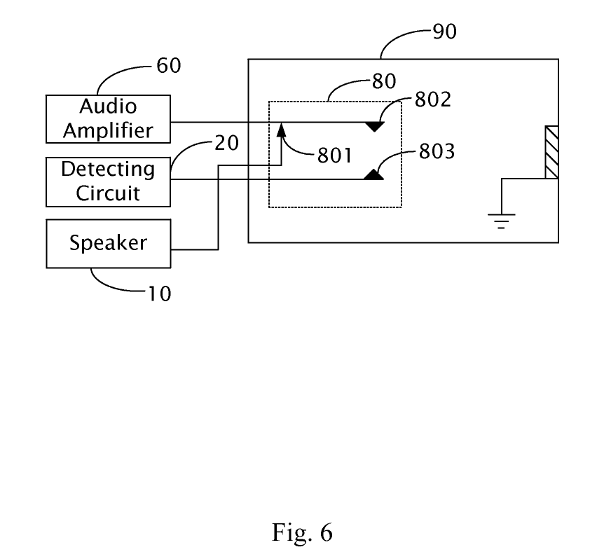

Referring to FIG. 5. FIG. 5 is a block diagram of a media player 1′ which can automatically adjust equalizer parameters thereof according to a second embodiment of the invention. In media player 1′, the detecting circuit 20 is configured for detecting a voltage of the second dynamic contact 803 of the switch 80, other parts are constructed in the same manner as those in the media player 1. Referring also to FIG. 6, the speaker 10 electrically connects with the static contact 801, the detecting circuit 20 electrically connects with the second dynamic contact 803, and the audio amplifier 60 electrically connects with the first dynamic contact 802. When the earphone jack 90 is empty, the static contact 801 connects with the first dynamic contact 802, thereby playing the analog audio signals via the speaker 10. The detecting circuit 20 detects the voltage of the second dynamic contact 803 and obtains a low level voltage value.

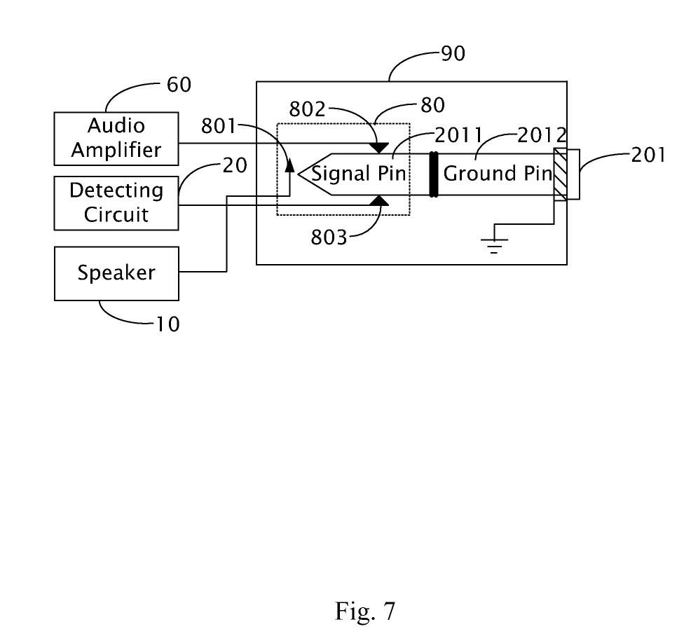

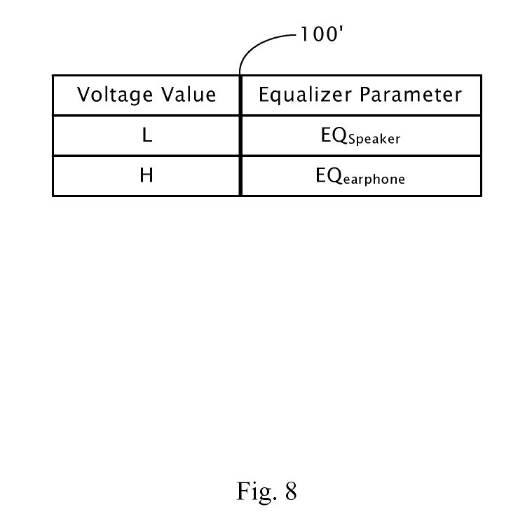

Referring also to FIGS. 7 and 8, when the earphone plug 201 of the earphone 2 is inserted into the earphone jack 90, the audio signal pin 2011 of the earphone plug 201 connects with the first dynamic contact 802 and the second dynamic contact 803, and the ground pin 2012 of the earphone plug 201 is grounded, thereby outputting audio signals via the earphone 2. The detecting circuit 20 obtains a high level voltage value. Because the static contact 801 is disconnected from the first dynamic contact 802, the speaker 10 cannot receive analog audio signals from the audio amplifier 60. In the second embodiment, the detecting circuit 20 is configured for detecting a voltage of the second dynamic contact 803 of the switch 80 and obtaining a detected voltage value. The processor 30 compares the detected voltage value with the predetermined voltage value stored in the memory 70 and obtains a comparison result. The processor 30 reads corresponding equalizer parameters according to the comparison result and a voltage value-equalizer parameter look-up table 100′ as shown in FIG. 8. The media player 1′ processes the audio signals according to the equalizer parameter read by the processor 30, thereby obtaining an ideal audio effect.

Although the present invention has been specifically described on the basis of a preferred embodiment and method thereof, the invention is not to be construed as being limited thereto. Various changes or modifications may be made to the embodiments without departing from the scope and spirit of the invention.

What is claimed is:

1. A media player capable of automatically adjusting equalizer parameters thereof, comprising:
a memory configured for storing equalizer parameters of the media player;
a speaker configured for outputting audible sounds;
an earphone jack configured for connecting an earphone to output the audible sounds;
a switch configured for disconnecting the speaker from outputting the audible sounds when the earphone jack is inserted in the earphone;
a detecting circuit configured for detecting a voltage of the speaker or of the switch and obtain a detected voltage value; and
a processor configured for comparing the detected voltage value with predetermined voltage values, determining whether the speaker or the earphone is used to output the audible sound according to the comparison result, and selecting corresponding equalizer parameters suitable for the speaker or the earphone to output the audible sounds.

2. The media player as claimed in claim 1, wherein the memory stores a voltage value-equalizer parameter look-up table which defines a corresponding relationship of a plurality of voltage values and the equalizer parameters.

3. The media player as claimed in claim 1, wherein the switch comprises a static contact, a first dynamic contact and a second dynamic contact, when the earphone jack is not inserted in the earphone, the static contact is connected with the first dynamic contact and audio signals are transmitted to the speaker via the first dynamic contact and the static contact; when the earphone jack is inserted with the earphone, the static contact is disconnected from the first dynamic contact and the audio signals are transmitted to the earphone via the first dynamic contact.

4. The media player as claimed in claim 3, wherein the detecting circuit electrically connects with the speaker, and detecting the voltage of the speaker and obtain a detected voltage value.

5. The media player as claimed in claim 4, wherein if the detecting circuit is configured for detecting a voltage of the speaker, the detecting circuit detects a high level voltage value if the earphone jack is not inserted in the earphone, and the processor reads equalizer parameters suitable for the speaker to output audible sounds, the detecting circuit detects a low level voltage value if the earphone jack is inserted in the earphone and the processor reads equalizer parameters suitable for the earphone to output the audible sounds.

6. The media player as claimed in claim 3, wherein if the detecting circuit is configured for detecting a voltage of the switch, the detecting circuit is electrically connected with the second dynamic contact of the switch, the detecting circuit detects a high level voltage value if the earphone jack is inserted in the earphone and the processor reads equalizer parameters suitable for the earphone to output the audible sounds; the detecting circuit detects a low level voltage value if the earphone jack is not inserted in the earphone and the processor reads equalizer parameters suitable for the speaker to output the audible sounds.
